(19) United States
(12) Patent Application Publication
(10) Pub. No.: US 2023/0227334 A1
(43) Pub. Date: Jul. 20, 2023

(54) DEVICE FOR WATER TREATMENT

(71) Applicant: OMITALY S.R.L., Magenta (IT)

(72) Inventors: Alessandro GALBIATI, Milano (IT); Massimo GALBIATI, Milano (IT); Andrea GALBIATI, Milano (IT); Davide GALBIATI, Milano (IT)

(73) Assignee: OMITALY S.R.L., Magenta (IT)

(21) Appl. No.: 18/010,626

(22) PCT Filed: Jun. 14, 2021
(86) PCT No.: PCT/IB2021/055214

§ 371 Date: Dec. 15, 2022

(30) Foreign Application Priority Data
Jun. 15, 2020 (IT) 102020000014218

(51) Int. Cl. C02F 1/36; C02F 1/48; C02F 1/00

(52) U.S. Cl. CPC C02F 1/36; C02F 1/481; C02F 1/005; C02F 2307/14; C02F 2303/04; C02F 2303/22; C02F 2301/024; C02F 2201/003; C02F 2201/004; C02F 2301/028; C02F 2201/48

(57) ABSTRACT

The present invention relates to a device (1) for liquid treatment, comprising an outer tubular body (10, 20, 30) with an extension along a longitudinal axis a; an inlet conduit (10) for a water flow; an outlet conduit (20) of the water flow in fluid communication with said inlet conduit (10); a central body (45) contained in a central zone inside said outer tubular body (10, 20, 30) and in contact with said water flow, the central body (45) comprising a plurality of discs (40, 41, 42, 43, 44) aligned longitudinally along the direction of the water flow, each of which has one or more holes (40a, 40b, 40c, 40d, 40e, 40f) arranged in a circular crown, each central disc (40, 41, 42, 43, 44) being rotated by a predetermined angle with respect to the preceding central disc (40, 41, 42, 43, 44).

### TECHNICAL FIELD

The present invention relates to a device for water treatment. In particular, the invention relates to a hydrodynamic device for the treatment of water for civil and industrial use.

The device of the present invention is applied in the civil, industrial, agricultural, chemical, floricultural, sanitary food (human and veterinary) fields, for the treatment of water in the recreational field (swimming pools, spas, whirlpools) and in the field of environmental and ecological treatments.

In the following discussion, reference is made to a device for water treatment for ease of exposure, but the device described herein is adapted to the treatment of any other liquid.

### PRIOR ART

Water intended for purification is withdrawn from the environment and subsequently treated specifically to ensure compliance with the quality limits established by law.

In detail, the water for civil or industrial use distributed to users can have high salinity, in particular, it can contain calcium salts, heavy metal residues, bacteria or other microorganisms and have a high viscosity.

Usually, the water distributed to users is treated with substances adapted to eliminate any bacterial load present therein and prevent the proliferation thereof. For example, chlorine is one of the most widely used substances to ensure the total absence of microorganisms harmful to man in drinking water, but it can make the taste and smell thereof very unpleasant.

However, such substances added to the distributed water do not eliminate the presence of any suspended substances such as, for example, calcium salts and heavy metals.

The aforementioned suspended substances are harmful to both users and plants, for example heavy metals bind to vital cellular components and calcium salts form limestone residues, known to be harmful to both pipes and kidneys.

Furthermore, the presence of limestone reduces the solvent and wetting power of water, thus the cleaning capacity, which leads to the use of greater amounts of surfactants with a negative environmental impact.

For the reasons set out above, the need to remove said suspended substances is strongly felt.

Therefore, in order to further improve the quality of water arriving from the water mains, various treatment devices are known.

For example, water treatment plants comprising different types of filtering elements arranged in succession are known.

Non-chemical devices using magnets capable of partially removing limestone and heavy metal residues in a more environmentally-friendly manner than the use of chemicals are also known.

However, water treatment by means of magnets has a relatively low effect, which can be improved by producing a strong turbulence but which would increase hydraulic resistance and pressure loss. Another disadvantage of such devices is a strong dependence of the effectiveness of such devices on water hardness.

### OBJECT OF THE INVENTION

The present invention relates to a device for water treatment as defined in the accompanying claim 1 and the preferred embodiments thereof disclosed in dependent claims 2 to 21.

The Applicant has perceived that the device for water treatment in accordance with the present invention allows to reduce the pressure drops normally necessary to obtain the expected result.

Another advantage of the present invention is to allow the non-use of external energy sources, both thermal and electrical.

A further advantage of the present invention is to allow a considerable reduction of the bacterial load.

Another advantage of the present invention is to allow a reduction of water viscosity.

A further advantage of the present invention is to transform calcium salts, making limestone less encrusting.

Another advantage of the present invention is to reduce surface tension and increase the wetting properties of water.

A further advantage of the present invention is to allow the creation of strong turbulence in the liquid flow, reducing hydraulic resistance and pressure loss.

Another advantage of the present invention is to reduce water clusters to groups of seven to eight molecules.

Another advantage of the present invention is the ease of installation in new or existing water treatment plants.

A further advantage of the present invention is that the device is simple and economical to make and assemble.

The technical effects/advantages mentioned, and other technical effects/advantages of the invention, will emerge in further detail from the description provided herein below of an example embodiment provided by way of approximate and non-limiting example with reference to the appended drawings.

### BRIEF DESCRIPTION OF THE DRAWINGS

Additional features and advantages of the invention will become more apparent from the description which follows of a preferred embodiment and the variants thereof, provided by way of example with reference to the appended drawings, in which:

FIG. 1 depicts a view of the outer casing of the device for water treatment;

FIG. 2 depicts a top view of the casing of FIG. 1;

FIG. 3 depicts an axial view of the casing of FIG. 1, from the water inlet part;

FIG. 4 depicts a section along the line IV-IV of FIG. 3;

FIG. 5 depicts a perspective view of the casing of FIG. 1;

FIG. 6 depicts the inlet fitting of the device of FIG. 1;

FIG. 7 depicts an axial view of the fitting of FIG. 6 from which the water enters;

FIG. 8 depicts a section along the line VIII-VIII of FIG. 7;

FIG. 9 depicts a perspective view of the fitting of FIG. 6;

FIG. 10 depicts the inlet locking fitting;

FIG. 11 depicts an axial view of the fitting of FIG. 10;

FIG. 12 depicts a section along the line XII-XII of FIG. 11;

FIG. 13 depicts a perspective view of the fitting of FIG. 10;

FIG. 14 depicts the outlet locking fitting of the device of FIG. 1;

FIG. 15 depicts an axial view, of the fluid outlet, of the fitting of FIG. 14;

FIG. 16 depicts a section along the line XVI-XVI of FIG. 15;

FIG. 17 depicts a perspective view of the fitting of FIG. 14;

FIG. 18 depicts the magnet carrying cap of the device of FIG. 1;

FIG. 19 depicts an axial view of the cap of FIG. 18;

FIG. 20 depicts a section along the line XX-XX of FIG. 19;

FIG. 21 depicts a perspective view of the cap of FIG. 18;

FIG. 22 depicts the locking plug of the longitudinal centring element;

FIG. 23 depicts a first axial view of the plug of FIG. 22;

FIG. 24 depicts a second axial view of the plug of FIG. 22, opposite that of FIG. 23;

FIG. 25 depicts the plug 22 in perspective view;

FIG. 26 depicts the longitudinal centring element;

FIG. 27 depicts an axial view of the longitudinal element of FIG. 26;

FIG. 28 depicts a section along the line XXVIII-XXVIII of FIG. 27;

FIG. 29 depicts a perspective view of the element of FIG. 26;

FIG. 30 depicts a side view of a set of two discs;

FIG. 31 depicts the two discs of FIG. 30 in axial view;

FIG. 32 depicts a section along the line XXXII-XXXII of FIG. 31;

FIG. 33 depicts a perspective view of the two discs of FIG. 30;

FIG. 34 depicts a side view of a set of four discs;

FIG. 35 depicts a section along the line XXXV-XXXV of FIG. 34;

FIG. 36 depicts a first axial view of the four discs of FIG. 34;

FIG. 37 depicts a second axial view of the four discs of FIG. 34, opposite that of FIG. 36;

FIG. 38 depicts a section along the line XXXVIII-XXXVIII of FIG. 37;

FIG. 39 depicts a section along the line XXXIX-XXXIX of FIG. 37;

FIG. 40 depicts a perspective view of the four discs of FIG. 34;

FIG. 41 depicts a side view of a central portion of the device of FIG. 1 comprising a plurality of discs of FIGS. 30 to 39;

FIG. 42 depicts a first axial view of the central body of FIG. 41;

FIG. 43 depicts a section along the line XLIII-XLIII of FIG. 42;

FIG. 44 depicts a second axial view of the central body of FIG. 41, opposite that of FIG. 42;

FIG. 45 depicts a side view of the device for water treatment according to the present invention;

FIG. 46 depicts an axial view of the device of FIG. 45;

FIG. 47 depicts a section along the line XLVII-XLVII of FIG. 46;

FIG. 48 depicts a section along the line XLVIII-XLVIII of FIG. 47;

FIG. 49 depicts a section along the line XLIX-XLIX of FIG. 47;

FIG. 50 depicts a section along the line L-L of FIG. 47;

FIG. 51 depicts a packet of central discs in axial view with a “square” shape;

FIG. 52 depicts a packet of central discs in axial view with a “hexagonal” shape;

FIG. 53 depicts a packet of central discs in axial view with an “eight” shape;

FIG. 54 depicts a packet of central discs in axial view with a “triangle” shape;

FIG. 55 depicts a first disc in axial view, at the inlet;

FIG. 56 depicts a section along the line LVI-LVI of FIG. 55;

FIG. 57 depicts the first disc of FIG. 55 in axial view, at the outlet;

FIG. 58 depicts a second disc in axial view, at the inlet;

FIG. 59 depicts a section along the line LIX-LIX of FIG. 58;

FIG. 60 depicts the second disc of FIG. 58 in axial view, at the outlet;

FIG. 61 depicts a section of a packet consisting of the first disc of FIG. 55 to the second disc of FIG. 58;

FIG. 62 depicts a side view of a central portion of the device of FIG. 1 comprising a plurality of pairs of discs of FIGS. 55 to 60;

FIG. 63 depicts a section along the line LXIII-LXIII of FIG. 62;

FIG. 64 depicts a section along the line LXV-LXV of FIG. 45

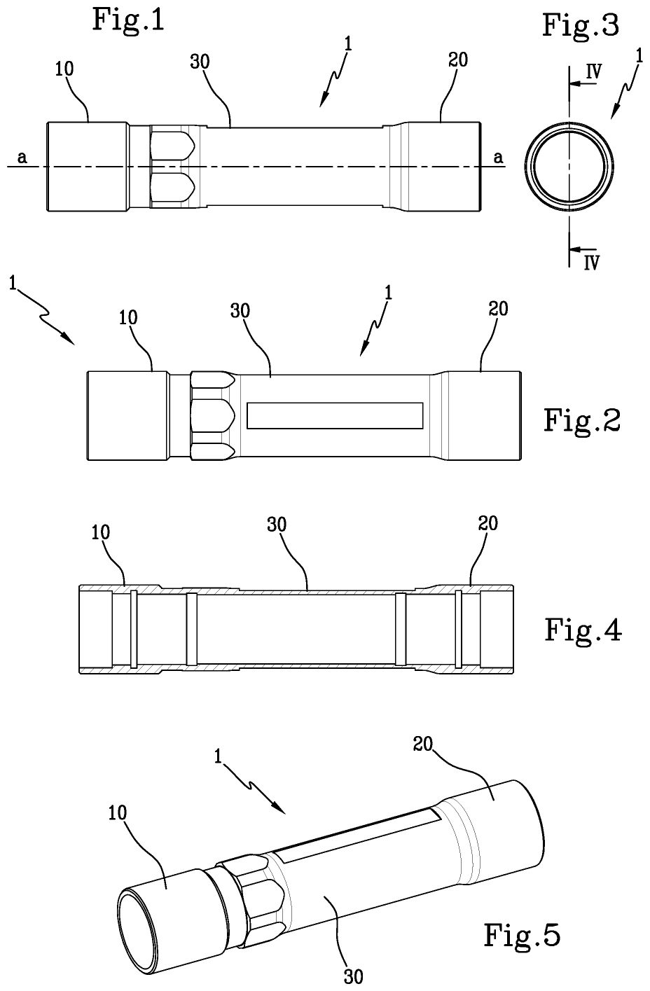

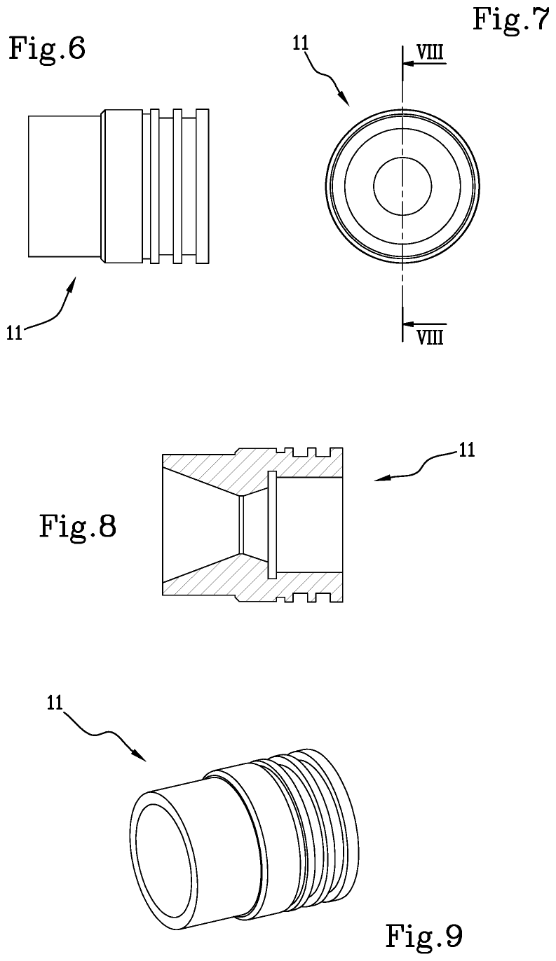

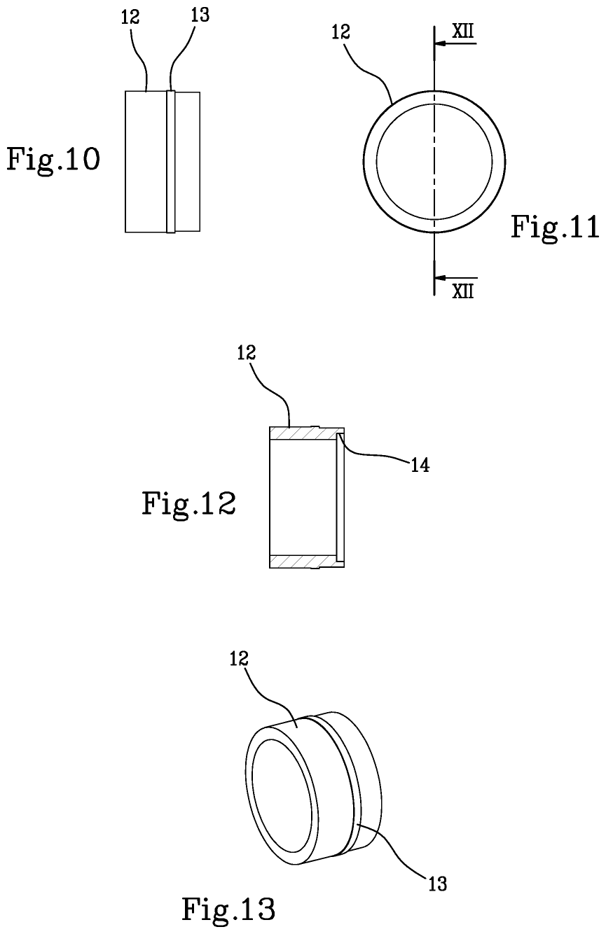

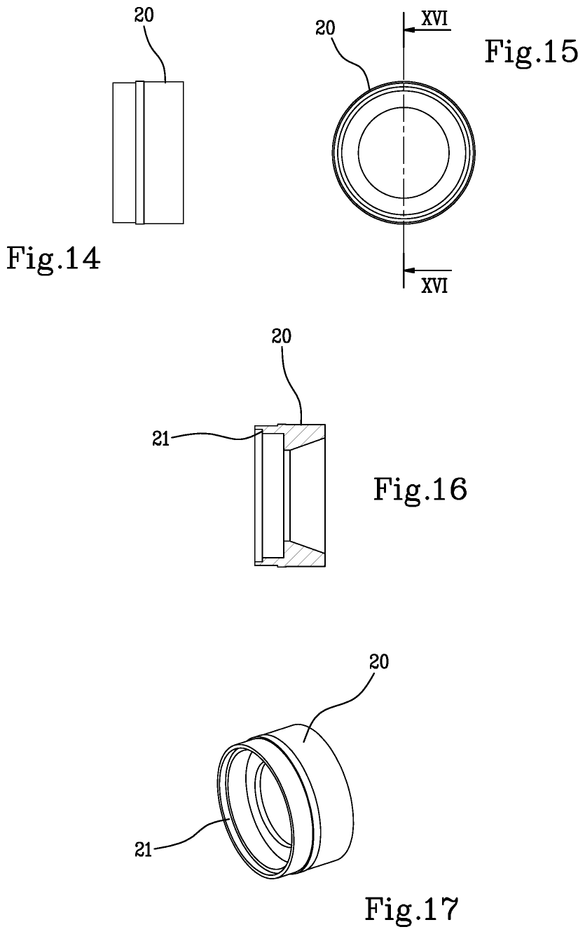

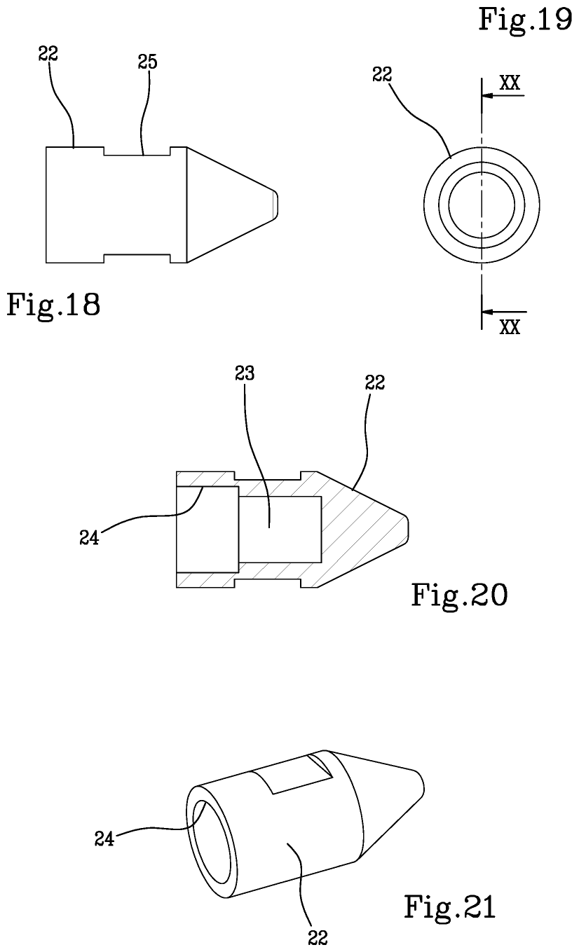

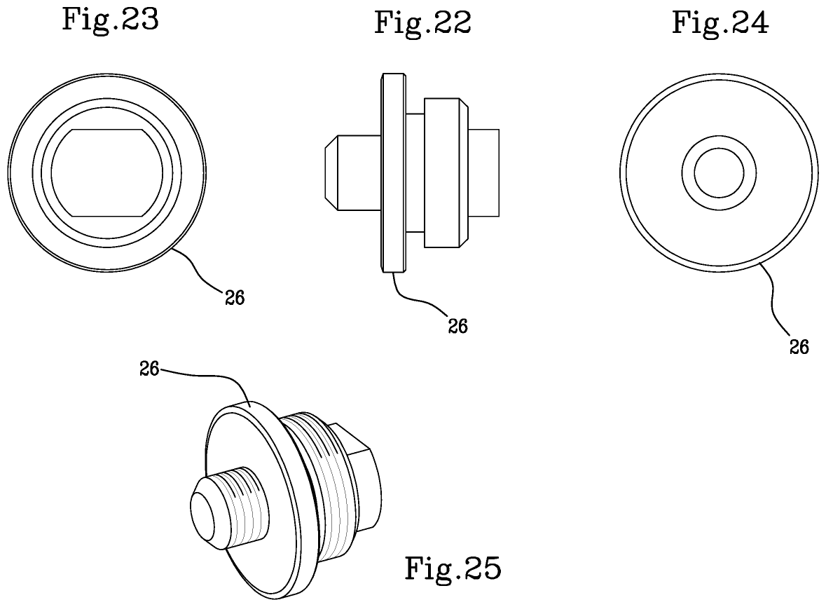

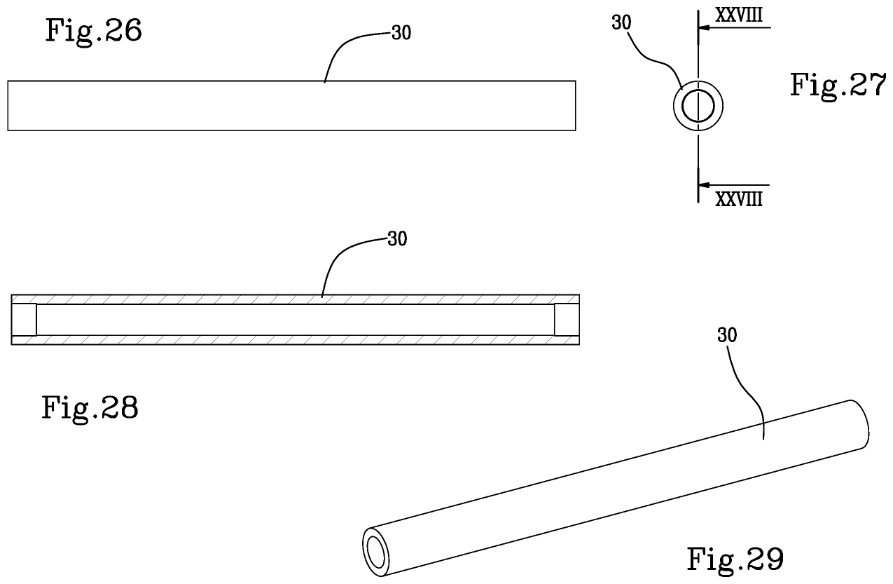

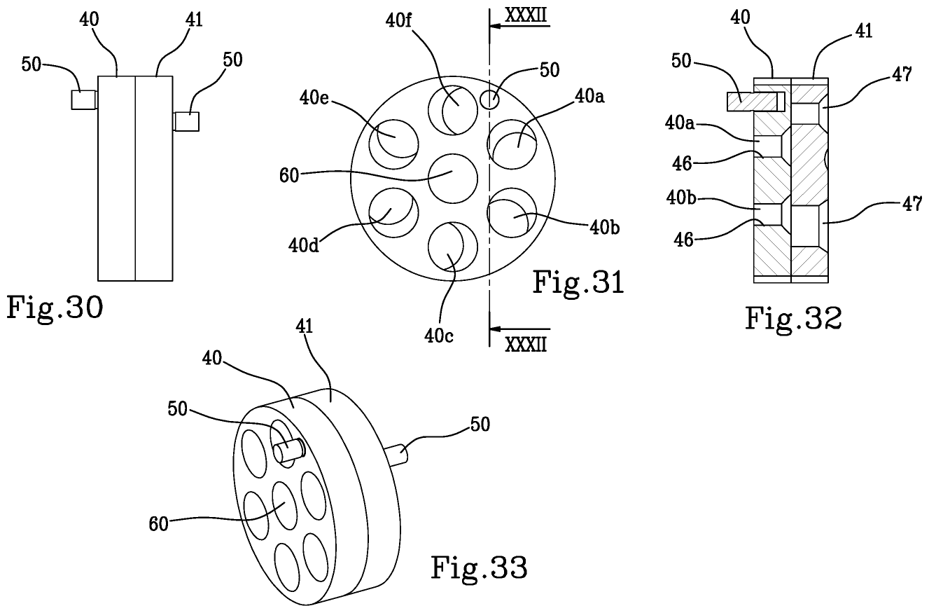

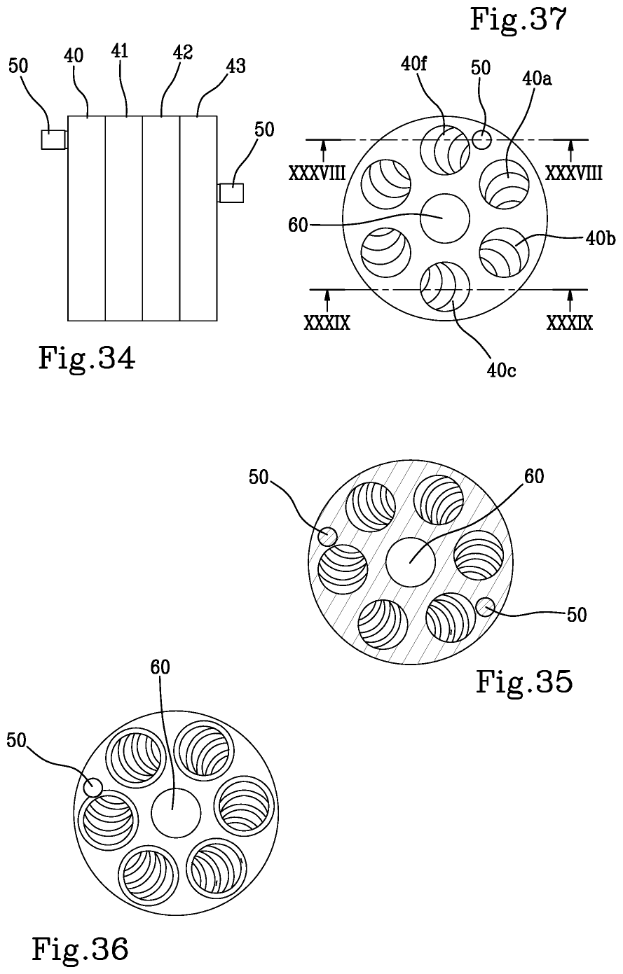

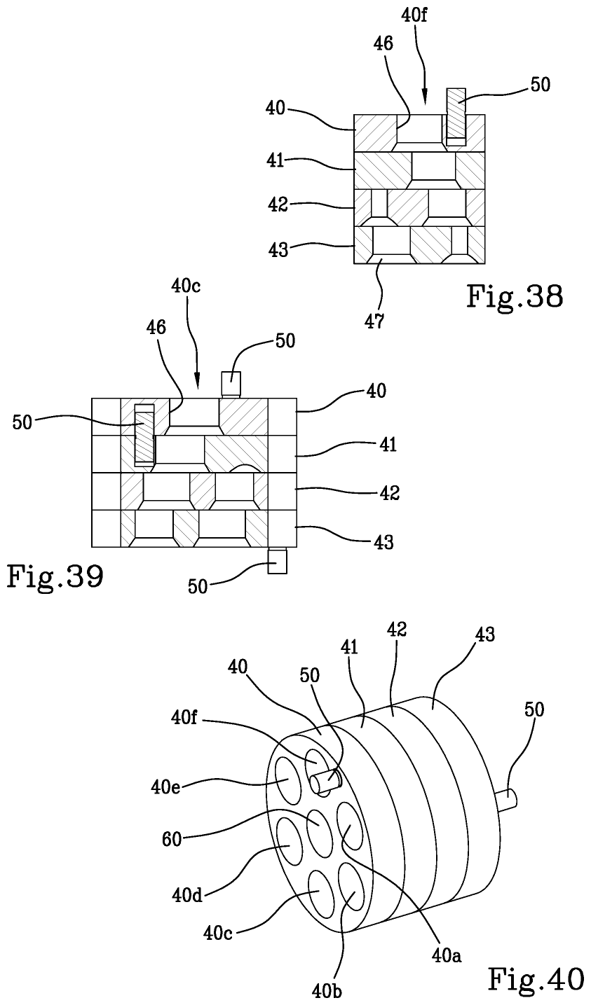

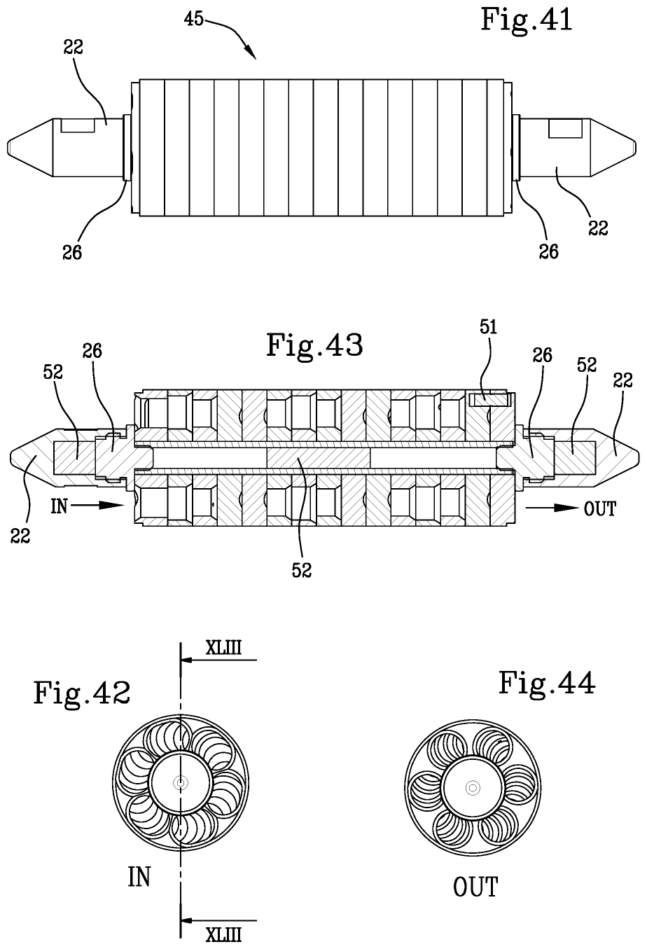

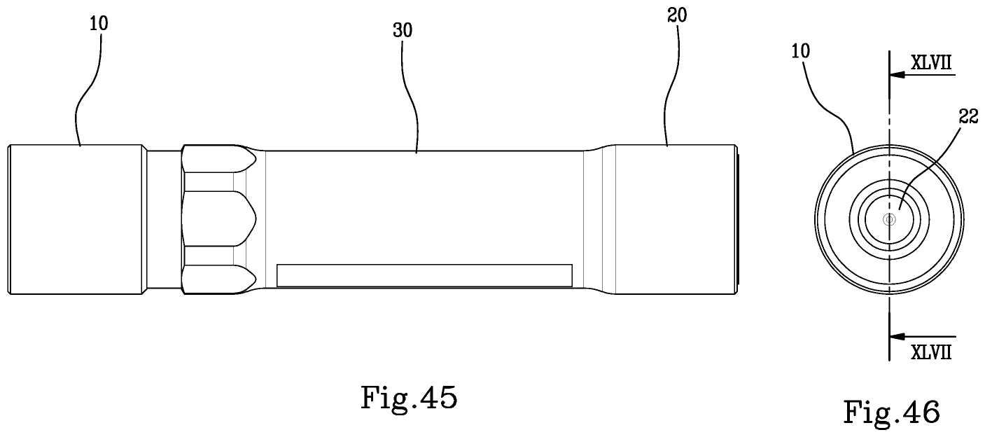

### DETAILED DESCRIPTION OF PREFERRED EMBODIMENTS OF THE INVENTION

The device for water treatment or for the treatment of other liquids according to the present invention is indicated in the appended figures with reference numeral 1.

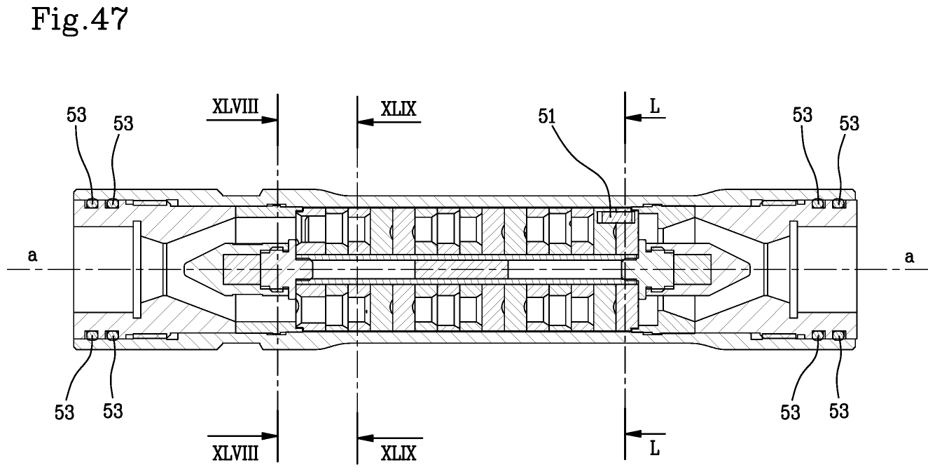

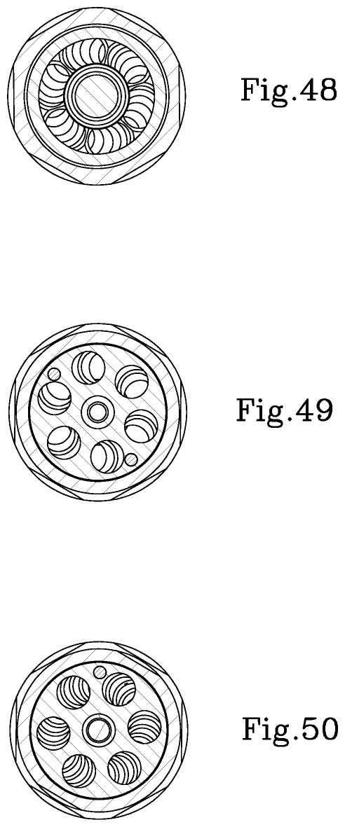

FIG. 47 shows a longitudinal section of the device 1, which is a conduit which externally has an outer tubular shape 10, 20, 30 which is substantially elongated along a longitudinal axis a-a.

The device 1 comprises an inlet conduit 10 for a water flow, intended to be installed after the water meter of a house or any civil or industrial structure described above.

In the outer part of the sleeve 10, 20, 30 there is a threaded hole which allows housing a cable having the function of grounding so as to interrupt possible dispersed or stray electric currents.

The attachment of the water inlet 12 has a special seat for the connection with the general water pipe.

The element 12 is preferably made of polyethylene for food use and has the function of interrupting the passage of any dispersed or stray electric currents present in the water system to which the device is connected.

The device 1 comprises downstream of the water flow an outlet conduit 20 of the water flow, in fluid communication with the inlet conduit 10, also preferably made of polyethylene for food use.

The device 1 further comprises a central body 45, as illustrated in FIG. 43, contained in a central zone inside the outer tubular body 10, 20, 30 and in contact with the water flow.

The central body 45 consists of a plurality of discs 40, 41, 42, 43, 44 aligned longitudinally along the axial direction (axis a-a) of the water flow, each of which has one or more holes 40a, 40b, 40c, 40d, 40e, 40f arranged in a circular crown.

Each central disc 40, 41, 42, 43, 44 is rotated at a predetermined angle with respect to the preceding central disc 40, 41, 42, 43, 44, so as to allow the flowing liquid to impact each disc passage 40, 41, 42, 43, 44 generating a mechanical effect that will result in a hydrodynamic cavitation process.

In particular, in the water flow passing through the device, ultrasonic waves are induced, which contribute to improving the properties of the water.

Since each disc is rotated by a predetermined angle, between the holes 40a, 40b, 40c, 40d, 40e, 40f adjacent for the passage of water from adjacent discs, a winding path is generated for the water flow passing through the device 1 capable of generating the hydrodynamic cavitation effect.

Preferably, the assembly of the discs 40a, 40b, 40c, 40d, 40e, 40f is achieved by means of pins 50, with rotation between one disc and the next disc by an angle varying from 1 to 350 degrees.

The central discs 40a, 40b, 40c, 40d, 40e, 40f may be in variable numbers, as a function of the results to be obtained, although for ease of exposure in the appended figures packets formed by two or four or fifteen adjacent central discs are shown.

The discs may have cylindrical holes or any other geometric shape that gives rise to a possible delta in terms of fluid pressure and flow rate.

The central portion 45 of central discs also comprises an inlet disc, at the entering water flow, and an outlet disc, at the exiting flow.

The number, shape and size of the holes 40a, 40b, 40c, 40d, 40e, 40f of the central discs 40, 41, 42, 43, 44 are not necessarily the same as those present in the inlet disc, while they are the same as those of the outlet disc.

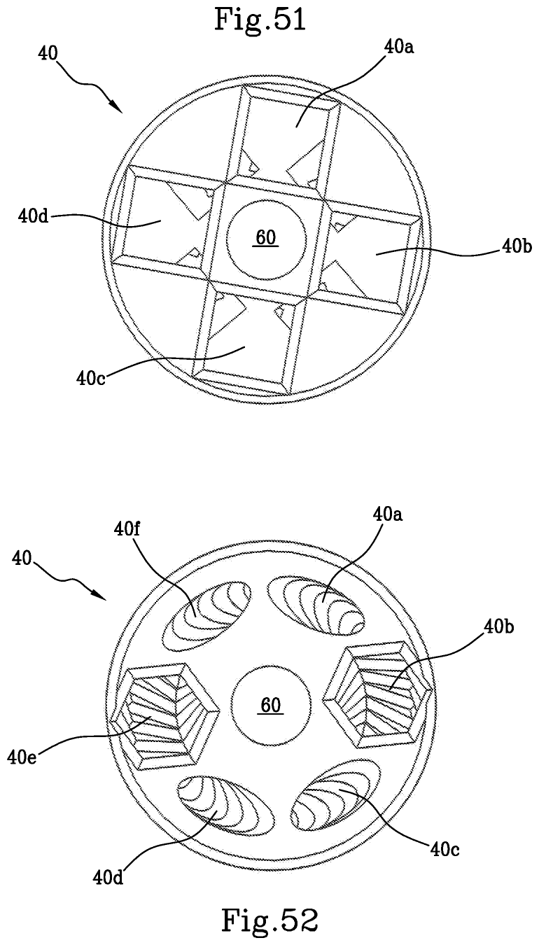

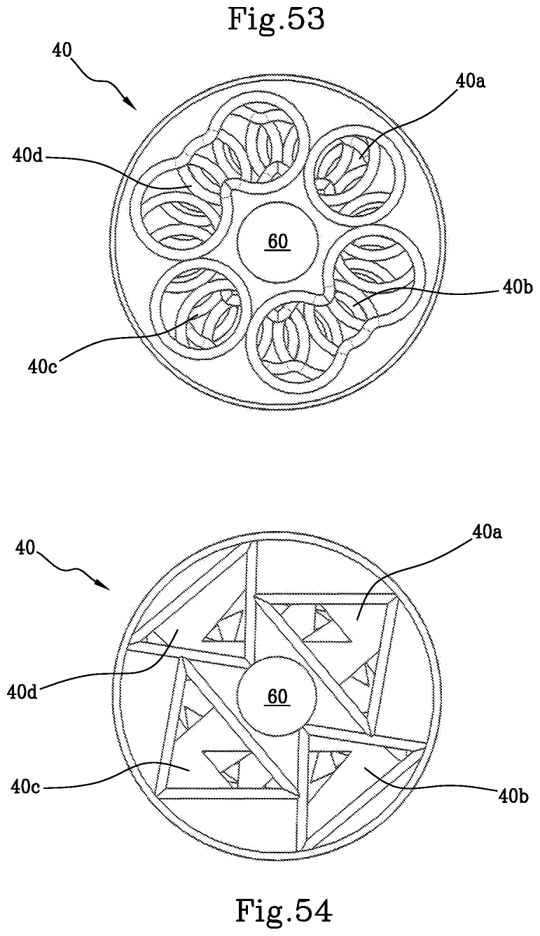

FIGS. 51 to 54 illustrate, by way of non-limiting example, four other different types of holes 40a, 40b, 40c, 40d, 40e, 40f of the central discs 40, 41, 42, 43, 44, respectively, holes having a “square” shape, a “hexagonal” shape, an “eight” shape and a “triangle” shape.

The holes 40a, 40b, 40c, 40d, 40e, 40f have on the water outlet side a divergence or countersink 47 having a variable angle as a function of the intended use of the device 1, with the function of allowing a sudden variation in fluid pressure and flow rate, creating micro-cavitations.

In the assembly sequence of the central discs 40, 41, 42, 43, 44, each of them is rotated with respect to the preceding one according to a determined angle. This allows the flowing liquid to impact each disc passage, thus generating a mechanical effect that will give rise to the hydrodynamic cavitation process.

The inlet disc has one or more holes arranged in a circular crown partially at the holes 40a, 40b, 40c, 40d, 40e, 40f of the central discs 40, 41, 42, 43, 44.

Each hole of the inlet disc has a bevel 46 at the water inlet (adapted to facilitate the water flow) and, at the opposite end of the water outlet, a countersink 47 (adapted to create a delta in terms of pressure and flow rate).

Preferably, the inlet disc comprises a number of holes equal to the number of holes 40a, 40b, 40c, 40d, 40e, 40f of the central discs 40, 41, 42, 43, 44 and is also rotated by a predetermined angle with respect to the first of the central discs.

Preferably, each hole 40a, 40b, 40c, 40d, 40e, 40f of each central disc 40, 41, 42, 43, 44 has a cylindrical shape.

Each central disc 40, 41, 42, 43, 44 comprises at least one hole or seat configured to house a locking element 50.

Preferably, each central disc 40, 41, 42, 43, 44 comprises two holes or seats present on opposite surfaces of each disc 40, 41, 42, 43, 44, each hole being configured to house a locking element 50.

Each central disc 40, 41, 42, 43, 44 is constrained on the adjacent central disc 40, 41, 42, 43, 44 through an axial pin 50. It is thereby avoided that the discs can rotate around the longitudinal axis a-a.

The axial pin 50 further allows to maintain the discs 40, 41, 42, 43, 44 firmly locked on top of each other, preserving the mounting sequence from possible positioning errors or involuntary rotations.

Furthermore, the presence of each hole or seat for the locking element 50 of each central disc 40, 41, 42, 43, 44 determines said determined partial rotation angle of a disc 40, 41, 42, 43, 44 with respect to the previous disc 40, 41, 42, 43, 44 such that between the adjacent holes 40a, 40b, 40c, 40d, 40e, 40f for the passage of water from adjacent discs, a winding path for the water flow passing through the device is generated.

Each central disc 40, 41, 42, 43, 44, inlet disc and outlet disc comprise a through central axial hole 60 configured to make an axial joining element 30 pass through. Thereby, the discs are directed with each other, and kept centred along the central axis a-a of the outer casing 10, 20, 30.

Preferably, the axial joining element 30 has a cylindrical shape.

The axial joining element 30 is preferably hollow and is configured to house inside one or more magnets 52, as a function of the intended use of the device, whose function is to create a magnetic field adapted to modify the structure of the limestone present in the liquid.

Preferably each central disc 40, 41, 42, 43, 44 comprises four to six peripheral holes 40a, 40b, 40c, 40d, 40e, 40f.

The device 1 comprises a converging-diverging element 11 downstream and/or upstream of said central body 45 and crossed by the water flow.

The connecting element 60 is inserted through the central hole 60 of each inlet, central and outlet disc.

Subsequently, the ends of the central element 30 are closed with a locking plug 26, which contributes to keeping the discs packed and allows a cap 22 to be assembled on the opposite axial side.

At the opposite axial ends of the central body 45, a pair of caps 22 is constrained, each having a seat 24 configured to be constrained to one of the two axial ends of the central body 45 and an outer surface in fluid contact with the water entering and/or exiting said central body 45.

Preferably, the outer surface in contact with the water flow of each cap has a shape adapted to direct the water flow on the circular crown of the discs so as to facilitate the entry of water inside the holes of the discs. For example, it may have a wedge-shaped or triangular shape.

In other words, each closing cap 22 essentially has two technical effects: the first is to create a delta of pressure and flow rate of the water flow capable of conferring greater effectiveness to the instrument, the other is to direct the liquid towards the peripheral holes of the discs.

Preferably, the cap 22 comprises an inner seat configured to house a magnet 23.

Furthermore, the cap 22 comprises a threaded seat 24 for locking on the central body 45, in particular, on an axial protrusion of the closing element 26.

The closing element 26 comprises, on the axial side opposite to that constrained with the cap 22, an axial protrusion that is constrainable inside the axial joining element 30.

Preferably, the central discs 40, 41, 42, 43, 44, the inlet disc, the outlet disc, the cap 22 and the disc stopping pin 50 are made of one or more of the following materials:
brass with low lead content;
titanium;
stainless steel 316L;
Aluminium;
plastic materials.

The discs 40, 41, 42, 43, 44 of the central body 45, the inlet disc and the outlet disc undergo a galvanic silver plating surface treatment.

In both the inlet and outlet zones of the water flow, there is an inlet spacer and an outlet spacer whose function is to orient the central body 45 and lock it on the outer sleeve 10, 20, 30 by means of dimensional interference.

The spacer elements can be made of Titanium or Stainless Steel 316L.

At the engagement points of the device 1 to the water system, both at the inlet and the outlet, rubber O-ring seals 53 are inserted, so as to prevent fluid leakage. Said seals 53 can be inserted in a variable number from 2 to 4 elements, positioned both at the inlet and outlet in specific housing seats created in the inlet and outlet attachment.

Each of the elements described above can be made in different materials, evaluable as a function of the intended use of the instrument and the purposes pursued with the use thereof.

The succession of the axially arranged elements of the device 1 described so far, from the entrance to the exit of the water, schematically define four different zones: threaded inlet (zone 1), inlet cone (zone 2), hydrodynamic cavitation zone (zone 3) and outlet cone (zone 4).

### Zone 1—Threaded Inlet

Entering the instrument, in the part immediately after the coupling thread to the water conduit outside the device 1, the liquid undergoes a variation in speed and pressure such as to obtain the optimal features for the subsequent entry into the hydrodynamic cavitation zone or “turbine”.

In this zone, the seal against any leakage of liquid outside is ensured by the presence of rubber O-ring seals 53.

### Zone 2—Inlet Cone

The conicity of the part positioned in this zone allows a uniform distribution of the liquid in the “turbine” or hydrodynamic cavitation zone. The possible magnet 52 positionable therein allows a first structural modification process of the fluid.

### Zone 3—Cavitation Zone

This zone represents the “heart” of the device 1 of the present invention, i.e., the section through which the passage of the liquid generates most of the water transformation processes listed in the preceding point: hydrodynamic cavitation, bacterial depletion, reduction of viscosity, reduction of water clusters, significant decrease in the encrusting effects of limestone, better mixing if different liquids or a liquid with powders enters.

### Zone 4—Outlet Cone

In the passage through this zone the liquid undergoes a bottleneck, creating the correct pressure needed to return the liquid fibres to the correct position, thus amplifying the work of the magnet 52, inserted inside the element 22, on the structure of the water molecules.

The assembly of the device 1 for water treatment involves the four sequential steps described below.

### First Step: Assembly of the Central Part 45.

The locking plug or pin 26 of the discs is placed, which helps to keep the discs packed, in a vice, tightened at the milling point outside the central packet 45, and the pipe or axial centring element 30 of the discs is screwed to the bottom to then loosen the tightening by one turn, so that a clearance of a few mm can be created between the two elements. The pipe 30 should preferably be positioned vertically.

The inlet disc 39 is then fitted on the pipe 30, the first locking and positioning pin 51 is inserted and the first disc 40 of the sequence of central discs to be packed is then positioned.

The second disc stopping pin 50 is then inserted, proceeding in succession for all the envisaged central discs.

With this assembly sequence, the positioning of the discs with a precise and predetermined angle is quickly and effectively obtained, creating a winding path for the liquid which flows inside the sequence of holes of the packed discs.

When the final or outlet disc is positioned, the sequence of discs is blocked by inserting a disc locking pin or plug 26. Once everything is sealed, the caps 22 are positioned, preferably containing the magnets 52. Optionally, the food-grade seals inserted therein allow the seal thereof, in addition to avoiding contact between liquid and magnet 52. The assembly is firmly secured through mechanical fixing, for example, by means of threading.

With this last passage, the central body 45 is completed.

### Second Step

The inlet spacer 27 is keyed onto the outer sleeve 30, positioning it already in the correct final position.

The geometry of the spacer is such as to generate interference on the sleeve adapted to create a lock with the central body.

### Third Step

The central body 45 is introduced inside the outer sleeve 30, pushing it until it abuts the inlet spacer 27. Subsequently, the outlet spacer is inserted with the help of a press, necessary for the high degree of interference present. This same interference has the function of keeping the central body 45 locked in the desired position.

### Fourth Step

The assembly is completed with the insertion of the two inlet 10 and outlet 20 attachments functional to ensure a further locking of the central body. Lastly, O-ring seals 53 are inserted on these with the function of preventing accidental leakage of liquids in the operating step.

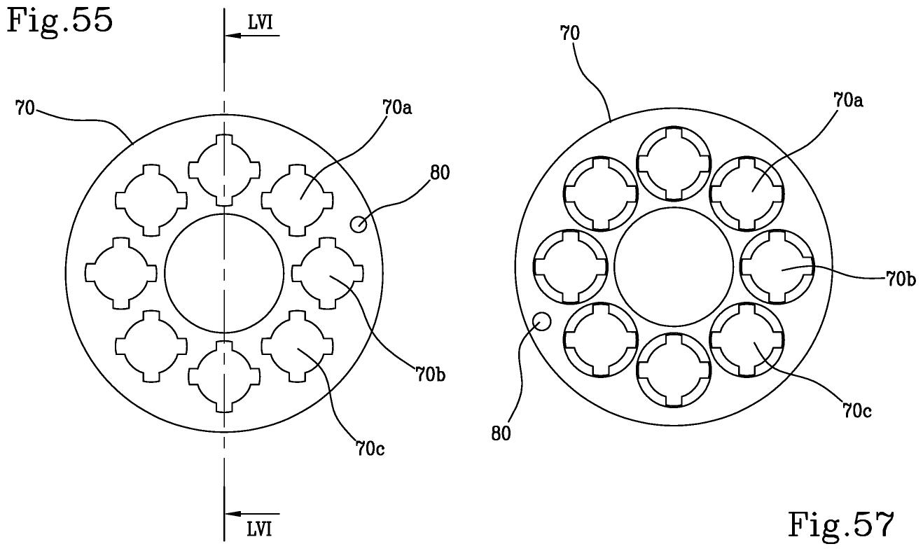

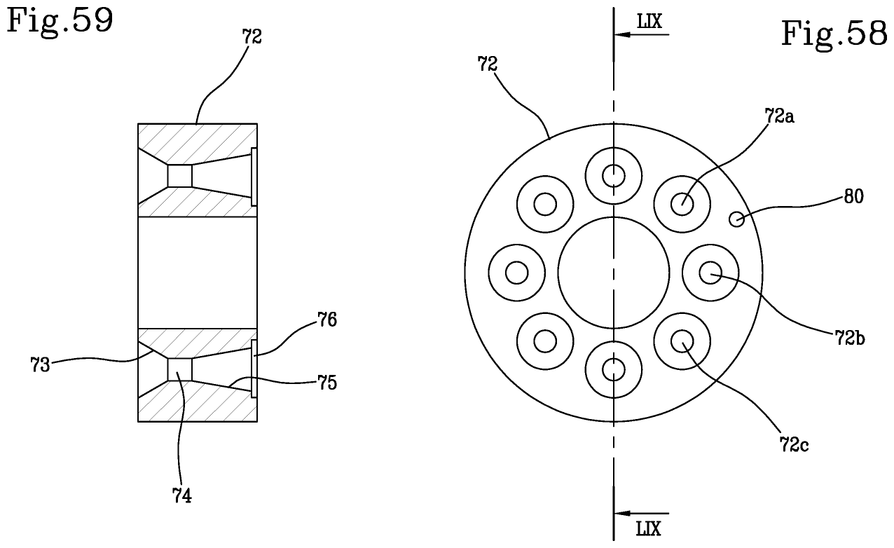

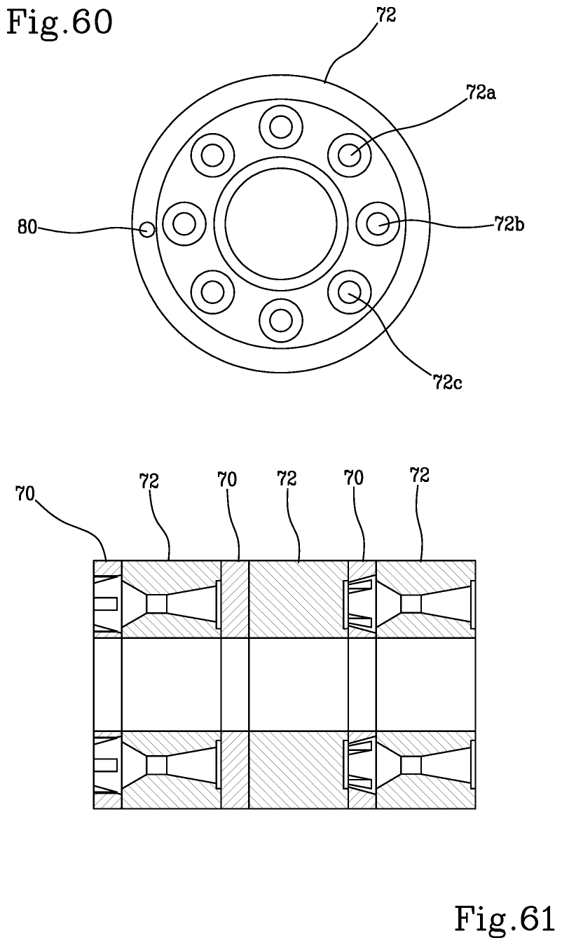

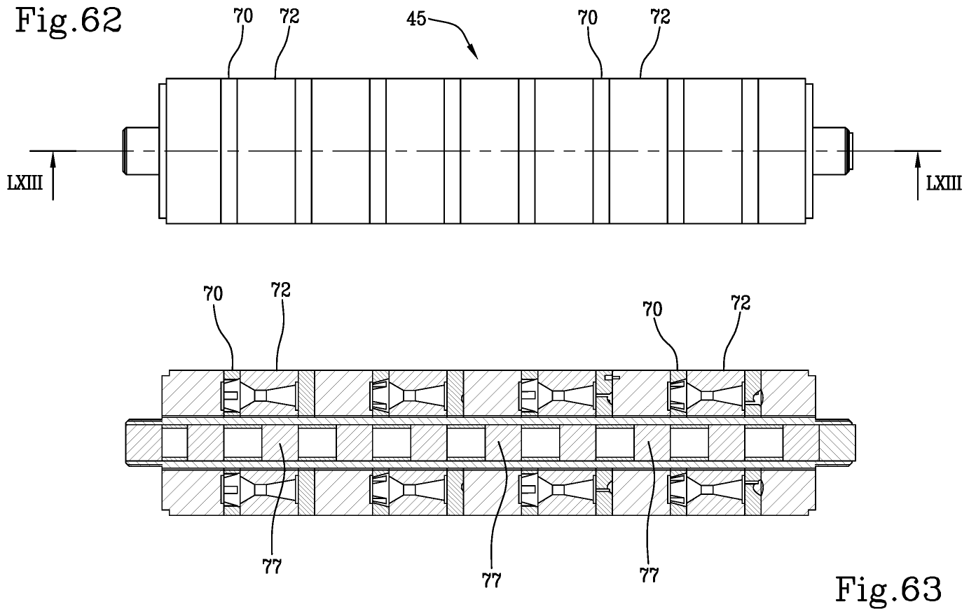

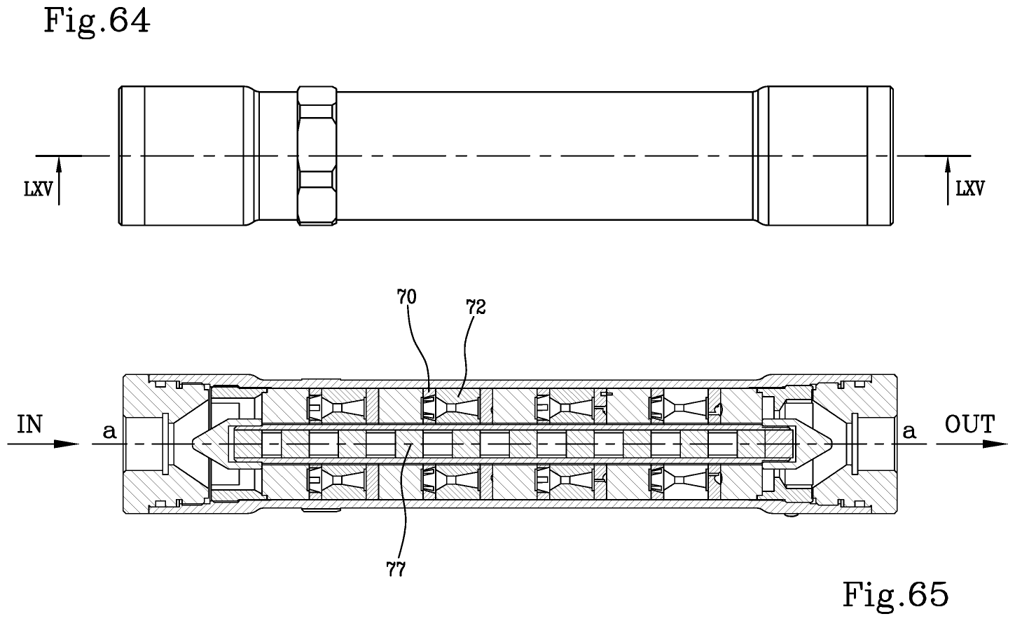

In a second embodiment of the present invention, the central body 45 of the device 1 consists of one or more pairs of discs as illustrated in FIGS. 55 to 65. All the other elements of the device 1 of the second embodiment illustrated below are identical to those described for the first embodiment of the present invention.

The inner part of the central body 45 of the second embodiment consists of a succession of pairs of discs 70, 72 packed together, each of which has a sequence of holes 70a, 70b, 70c, 72a, 72b, 72c of different shape, size and length between one disc and the other.

The number of pairs of discs 70, 72 is variable from a minimum of three pairs to a maximum to be defined according to the result to be obtained. Each single pair of discs 70, 72 consists of the packing two discs 70, 72.

FIG. 55 depicts a view of the fluid entering through a first disc 70, in which the entering fluid passes through one or more holes 70a, 70b, 70c, present on the peripheral circular crown of a first disc 70. Each hole 70a, 70b, 70c has in section, from the entrance to the exit of the liquid flow, one or more bevels or toothings 71 which allow to create angles that increase the edges on which the inlet liquid “collides”. Thereby, the first disc 70 allows to break down the surface tension on the liquid flow entering.

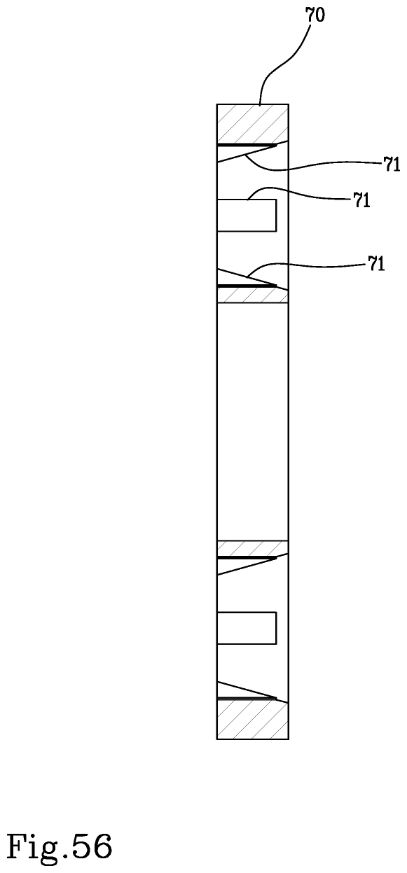

Preferably, as illustrated in FIG. 56, each hole 70a, 70b, 70c is partially conical and diverging from the liquid entrance towards the exit.

The second disc 72 is directly coupled to the exit of the first disc 70, comprises an equal number of holes 72a, 72b, 72c aligned and at the holes 70a, 70b, 70c of the first disc 70, so as to allow the passage of the liquid flow.

Each hole 72a, 72b, 72c has in section from the entrance to the exit of the liquid flow, as illustrated in FIG. 59, a first converging bevel 73, a cylindrical central part 74 and a second diverging bevel 75 (preferably having a greater length than that of the first bevel 73).

The first bevel 73 allows to facilitate the entrance of the liquid flow towards the smaller central narrowing 74. In the second bevel 75, from which the diameter of the central part 74 increases until the end of the second disc 72, the cavitation of the liquid flow occurs.

In other words, the interior of the second disc 72 has a plurality of holes therein, each of which forms a Venturi chamber capable of generating a cavitation.

Preferably, in the final part of the second disc 72 there is a front groove 76 to allow the exiting liquid to reunite, so as to create a turbulence. In other words, the front groove 76 embraces all the holes and has the function of creating a small tank which allows an increase in pressure and a turbulence adapted to mix the liquid and facilitate the supply of the liquid to the next packet of discs 70, 72.

This will serve to mix the liquid before it is pushed into the next packet of discs 70, 72, thus giving the liquid a mode for almost all of it to be processed, considering the fact that the passages are carried out on a very small diameter, so as to ensure the desired result.

Preferably, the first disc 70 has a thickness less than that of the second disc 72, as illustrated in the appended figures.

The locking of the first disc 70 on the second disc 72 is ensured by a tubular element, threaded at the ends, which slides in the central part of the pair of discs 70, 72, along the longitudinal axis a of the device 1.

Furthermore, on each disc 70, 72 there is a hole 80 on the peripheral zone, which hole is capable of accommodating a pin for positioning the first disc 70 to the second disc 72.

Preferably, magnets 77 may be present inside the longitudinal tubular element.

There are two conical caps for tightening on the two threaded ends.

When the liquid enters the pair of packed discs 70, 72, from the second packet of discs and following, we will find an undercut 71, so as to create a sort of blade to cut the liquid flow. Preferably, in the inner surface of the holes 72a, 72b, 72c of the disc 72, a broaching may also be present to increase the edges and create a larger work surface. The broaching, placed on the circumferences whose sum will be equivalent to twice the area of the initial pipe, will have the function of preparing the liquid entering the many Venturi chambers of the second disc 72.

The elements of the liquid will begin to separate, preparing the cavitation step which will then occur in the Venturi holes, favouring the implosion of the molecules. The break down which occurs at the first disc 70 will have the task of reducing the surface tension of the liquid.

Strongly reducing the surface tension will greatly help amplify the cavitation effects which will develop in the next pair of discs 70, 72.

The second disc 72 has a series of Venturi chambers equal to the number of passages or holes 72a, 72b, 72c.

The cavitation inside the holes of the second disc 72 favours the formation and movement of bubbles inside a liquid when it is subjected to the action of positive and negative pressure waves at very high speed, generating ultrasound with an intense ultrasound field. During the negative pressure step, a multitude of bubbles are created inside the liquid. During the second step of ultrasonic compression, the enormous pressure exerted on the bubbles decompresses them until they implode, i.e., collapse on themselves. This implosion of the molecule has the function of creating the elimination of bacterial load, in addition to the transformation of the calcium molecule into aragonite, making the liquid much less encrusting. The disc 72 has multiple passages, with a minimum of three (elements 73, 74 and 75 of FIG. 59) and a maximum to be defined, to find a compromise between desired effect and loss of flow.

The positioning of the holes between a pair of discs 70, 72 and the subsequent one does not follow, in this second embodiment, a spiral trend. In particular, the outlet holes 72a, 72b, 72c will be perfectly offset with the inlet holes 70a, 70b, 70c equal in size to half the diameter of the hole.

The holes of the first packet or pair of discs 70, 72 will therefore be in line with those of the third packet of discs 70, 72, of the fifth, of the seventh, etc., while the holes of the second will be aligned with those of the fourth, of the sixth, of the eighth, and so on depending on how many pairs of discs must be inserted in the central body 45. The goal to be achieved will determine the number of disc pairs needed. Certainly as the obstructions generated by the cavitations increase, there will be an increase in flow rate losses, for this reason, preferably with nine pairs of discs 70, 72, extraordinary certified results are achieved. However, nothing prevents increasing the number according to needs.

The present invention achieves the following technical effects:

Bacterial abatement without the use of chemicals and without the use of electricity or heat.

Decreased limestone aggressiveness.

It promotes the mixing of different liquids or liquids with any powders contained therein.

In the case of agricultural use, it promotes improved oxygenation of water, decreasing the viscosity thereof, in addition to obtaining better absorption of the same by living organisms, animals and plants, which benefit therefrom.

Reduction of the need to use cleaning and anti-limescale products in civil and industrial washing applications.

The galvanic silver plating treatment of the elements of the device 1 allows the advantage of a reduction of the bacteria present in the water, or in any other liquid.

Preferably, the device 1 can be made entirely of Titanium, a material particularly suited for applications in the medical field.

The insertion of magnets 52, hermetically sealed inside the central body 14 and/or the caps 22, allows to amplify the effects of the mechanical process generated.

In an embodiment of the invention, the central discs are made using different materials, in order to create, through the passage of the fluid, electrostatic energy which can be exploited for possible uses in alternative applications.

Making the engagement connection in polyethylene allows to reduce possible dispersions of stray electrostatic currents present in the system.

The device for water treatment illustrated allows a reduction of surface tension which in turn allows a greater surface exchange between water and any hydrophilic substances (e.g., hydrophilic portions of the molecules which form soaps and detergents) and greater solvent power and wettability. Therefore, the water passed through the device of the invention shows a better cleaning capacity and allows to reduce the use of detergents and surfactants.

This advantage is particularly important for domestic use.

Furthermore, the above mechanical disturbances hinder the formation of limestone residues from calcium salts and the precipitation and deposit thereof on pipes and other plants. The applicant has found that the natural tendency of calcium molecules to aggregate into the crystalline form of calcite (responsible for limestone formation) is hindered by the passage through the device of the invention.

It is clear that the specific features are described in relation to different embodiments of the invention with an exemplary and non-limiting intent.

Obviously a person skilled in the art can make further modifications and variants to the present invention, in order to satisfy contingent and specific needs. For example, the technical features described in relation to an embodiment of the invention can be extrapolated therefrom and applied to other embodiments of the invention. Such modifications and variations are moreover embraced within the scope of the invention as defined by the following claims.

1. A device (1) for water treatment, comprising:
an outer tubular body (10, 20, 30) with an extension along a longitudinal axis a;
an inlet conduit (10) for a water flow;
an outlet conduit (20) of the water flow in fluid communication with said inlet conduit (10);
said inlet conduit (10) and said outlet conduit (20) being aligned along said longitudinal axis a, at opposite ends of said outer tubular body (19, 20, 30);
a central body (45) contained in a central zone inside said outer tubular body (10, 20, 30) and in contact with said water flow, the central body (45) comprising a plurality of discs (40, 41, 42, 43, 44) packed and centred longitudinally along said longitudinal axis a of said outer tubular body (10, 20, 30), each of which has one or more holes (40a, 40b, 40c, 40d, 40e, 40f) arranged in a circular crown, each central disc (40, 41, 42, 43, 44) being rotated by a predetermined angle with respect to the preceding central disc (40, 41, 42, 43, 44).

2. The device (1) according to claim 1, wherein each hole (40a, 40b, 40c, 40d, 40e, 40f) of each central disc (40, 41, 42, 43, 44) has a cylindrical shape.

3. The device (1) according to claim 2, wherein each hole (40a, 40b, 40c, 40d, 40e, 40f) of the central discs (40, 41, 42, 43, 44) has a countersink (47) in the end of the water outlet.

4. The device (1) according to claim 3, wherein the central body (45) comprises an inlet disc having one or more holes arranged in a circular crown at the holes (40a, 40b, 40c, 40d, 40e, 40f) of the central discs (40, 41, 42, 43, 44).

5. The device (1) according to claim 4, wherein each hole of the inlet disc has a bevel (46) at the water inlet and, at the opposite water outlet end, has a countersink (47).

6. The device (1) according to claim 5, wherein the inlet disc comprises a number of holes equal to the number of holes (40a, 40b, 40c, 40d, 40e, 40f) of the central discs (40, 41, 42, 43, 44).

7. The device (1) according to claim 6, wherein each central disc (40, 41, 42, 43, 44) comprises at least one hole configured to house a locking element (50).

8. The device according to claim 7 , wherein each central disc (40, 41, 42, 43, 44) comprises two holes present on opposite surfaces of each central disc (40, 41, 42, 43, 44), each hole being configured to house a locking element (50).

9. The device according to claim 8, wherein each central disc (40, 41, 42, 43, 44) is constrained on the adjacent central disc (40, 41, 42, 43, 44) through an axial pin (50).

10. The device (1) according to claim 9, wherein each hole for the locking element (50) of each central disc (40, 41, 42, 43, 44) determines said determined partial rotation angle of a disc (40, 41, 42, 43, 44) with respect to the preceding central disc (40, 41, 42, 43, 44).

11. The device (1) according to claim 10, wherein each central disc (40, 41, 42, 43, 44) comprises a through central hole (60) configured to make an axial joining element (30) pass through.

12. The device (1) according to claim 10, wherein said axial joining element (30) is hollow.

13. The device (1) according to claim 11, wherein said axial joining element (30) is configured to house one or more magnets (52) therein.

14. The device (1) according to claim 13, comprising a converging-diverging element (11) downstream and/or upstream of said central body (45) and crossed by the water flow.

15. The device (1) according to claim 14, comprising a cap (22) having a seat (24) configured to be constrained to one of the two axial ends of said central body (45) and an outer surface in fluid contact with the water entering and/or exiting said central body (45).

16. The device (1) according to claim 15, wherein said cap (22) comprises an inner seat configured to house a magnet (23).

17. The device (1) according to claim 16, wherein the cap (22) comprises a thread for locking on the central body (45).

18. The device (1) according to claim 17, comprising a closing element (26) having an axial protrusion that is constrainable inside the axial joining element (30).

19. The device (1) according to claim 18, comprising a locking element locking to the seat (24) of the cap (22).

20. The device (1) according to claim 19, wherein the central discs (40, 41, 42, 43, 44) of the central body (45) and the inlet disc are made of one or more of the following materials:
brass with low lead content;
titanium;
stainless steel 316L;
Aluminium;
plastic materials.

21. The device (1) according to claim 20, wherein the central discs (40, 41, 42, 43, 44) of the central body (45) and the inlet disc undergo a galvanic silver plating surface treatment.

22. A device (1) for water treatment, comprising:
an outer tubular body (10, 20, 30) with an extension along a longitudinal axis a;
an inlet conduit (10) for a water flow;
an outlet conduit (20) of the water flow in fluid communication with said inlet conduit (10);
said inlet conduit (10) and said outlet conduit (20) being aligned along said longitudinal axis a, at opposite ends of said outer tubular body (19, 20, 30);
a central body (45) contained in a central zone inside said outer tubular body (10, 20, 30) and in contact with said water flow, the central body (45) comprising a plurality of pairs of discs (70, 72) packed and centred longitudinally along said longitudinal axis a of said outer tubular body (10, 20, 30),
each pair of discs (70, 72) comprises a first disc (70) and a second disc (72), the first disc (70) has a plurality of holes (70a, 70b, 70c) for the passage of water, the second disc (72) has a plurality of holes (72a, 72b, 72c) in fluid connection with the holes (70a, 70b, 70c) of the first disc (70), wherein each hole (70a, 70b, 70c) of the first disc (70) comprises a plurality of edges (71) configured to break down the surface tension of the entering water and each hole (72a, 72b, 72c) of the second disc (72) comprises a Venturi chamber.

23. The device (1) according to claim 22, wherein each hole (70a, 70b, 70c) of the first disc (70) is partially conical and diverging from the liquid inlet towards the outlet.

24. The device (1) according to claim 23, wherein each hole (72a, 72b, 72c) of the second disc (72) has in the section from the inlet towards the outlet of the liquid flow, a first converging bevel (73), a cylindrical central part (74) and a second diverging bevel (75).

25. The device (1) according to claim 24, wherein the second disc (72) is directly coupled to the outlet of the first disc (70) and comprises an equal number of holes (72a, 72b, 72c) which are aligned and at the holes (70a, 70b, 70c) of the first disc (70), so as to allow the passage of the water flow.

26. The device (1) according to claim 25, wherein the outlet holes (72a, 72b, 72c) of the second disc (72) of a pair of discs (70, 72) are offset with respect to the inlet holes (70a, 70b, 70c) of the first disc (70) of the next pair of discs (70, 72) by half the diameter of the hole diameter.

27. The device (1) according to claim 26, wherein the holes of the packs of discs (70, 72) in an even position present inside the central body (45) will be aligned with each other, while the holes of the packets of discs (70, 72) in an odd position will be aligned with each other.

28. The device (1) according to claim 27, wherein there are at least three pairs of discs (70, 72) inside the central body (45).
